(19) United States
(12) Patent Application Publication
(10) Pub. No.: US 2006/0221375 A1
(43) Pub. Date: Oct. 5, 2006

(54) Automatic secure print notification

(76) Inventors: Ramesh Nagarajan, Pittsford, NY (US); James Russell, Ontario, NY (US)

Correspondence Address: Clifford P. Kelly;Alix, Yale & Ristas, LLP, 750 Main Street, Hartford, CT, 06103-2721, US

(21) Appl. No.: 11/098,358

(22) Filed: Apr. 4, 2005

(51) Int. Cl. G06K 15/00

(52) U.S. Cl. 358/1.14; 358/1.15

(57) ABSTRACT

A method of managing secure print jobs in a distributed computer system includes storing secure print jobs and user ID data associated with the user in the printer system memory. A printer controller periodically transmits reminder messages to the user identified by the user ID data. The reminder messages inform the user that the secure print job is stored in a queue in the printer system and would be printed only on manual entry of an appropriate command at the printer system.

### BACKGROUND OF THE INVENTION

This invention relates generally to hardcopy production of documents. More particularly, the present invention relates to hardcopy production of documents by distributed network printers.

The continual emergence of faster, more powerful computers has driven down the cost of implementing “distributed” networks (e.g., local area networks and the like). These networks are advantageous in that each user has control over his or her own personal computer. Moreover, multiple users can be connected to less frequently used hardware equipment such as printers located in a public area accessible to all users. Typically, network printers are attached to computing platforms operating as print servers within distributed systems. Alternatively, some printers, given appropriate interfaces, can be arranged to connect directly to the network of a distributed system.

For the purpose of further discussion herein, the term “printer” shall include all different types of printer, or other hardcopy or document rendering apparatus and devices. Also, for the sake of convenience of description herein, the term “document” will hereafter be used to denote a document in any state, including (but not limited to) when viewed on a computer display, when formatted as a printer file ready for printing, and when in hardcopy form. The state the document is in at any point in the description depends on the context. Also, a “document” may include text, graphics or mixed representations.

One problem with printing documents on remote network printers is that any person near to the printer could remove or read printed documents containing sensitive information, which do not belong to them, before the intended recipients are able to retrieve the documents. One way around this is for users who need to print sensitive documents to arrange for a trusted person to stand by the printer while the document is printing and collect the document as soon as it has printed. This, of course, is inconvenient.

Another way to increase security is to submit sensitive documents to the print queue but to prohibit the printing of such documents until a print release command is entered by the user at the printer. In this type of environment, it is not unusual for numerous secure print jobs to stay in the print queue for significant periods of time before a print release command is entered. Often, the user simply forgets that he/she has submitted a secure printjob to the printer. Depending on the number of printjobs in the print queue, a large portion of the print server/printer memory may be occupied by secure print jobs waiting for a print release command. Also, other users of the printer must navigate through a LCD screen display of the print queue in order to find their jobs in the midst of these “un-printed” jobs.

### SUMMARY OF THE INVENTION

In accordance with the present invention, there is provided a method of managing secure print jobs in a distributed computer system. The method comprises commanding a user computer system to submit a secure print job for printing. The user computer system transmits the secure print job and user ID data associated with the user to the printer system through the network. The printer system controller then creates a record in the secure print job database and stores the print job file and user ID data in a print job field and an ID field of the record, respectively. The printer controller periodically transmits reminder messages to the user identified by the user ID data. The reminder messages inform the user that the secure print job is stored in a queue in the printer system and would be printed only on manual entry of an appropriate command at the printer system.

After the printer system stores the print job file and user ID data, the printer controller initiates a message timer associated with the secure print job to countdown and periodically queries the message timer for each secure print job to determine whether the message timer countdown has exceeded a preset timer interval setpoint. If the message timer countdown is less than the time interval setpoint, the message timer continues to countdown. If the message timer countdown is greater than the time interval setpoint, the printer controller transmits the reminder message to the user and resets the message timer to reinitiate countdown.

After the printer system initiates the message timer, the printer controller initiates a job timer associated with the secure print job to countdown and periodically queries the job timer for each secure print job to determine whether the job timer countdown has exceeded a preset timer interval setpoint. If the job timer countdown is less than the time interval setpoint, the job timer continues to countdown. If job the timer countdown is greater than the time interval setpoint, the printer controller deletes the print job file and user ID data and returns to standby for receipt of another secure print job. If job the timer countdown is greater than the time interval setpoint, the printer controller also transmits a message informing the user that the print job has been canceled.

After the printer controller has determined that the timer countdown is greater than the time interval setpoint and before the printer controller transmits the reminder message to the user, the printer controller queries the print job record to determine whether the print status field has been annotated. If the print job record indicates that the print job has been printed, the printer controller deletes the print job file and user ID data and returns to standby for receipt of another secure print job. If the print job record indicates that the print job has not been printed, the printer controller transmits the reminder message to the user.

### BRIEF DESCRIPTION OF THE DRAWINGS

The present invention may be better understood and its numerous objects and advantages will become apparent to those skilled in the art by reference to the accompanying drawings in which:

FIG. 1 is a schematic diagram of a local area network using the method of the subject invention; and

FIG. 2 is a flow diagram of a method for automatic secure print notification in accordance with the invention.

### DETAILED DESCRIPTION OF THE PREFERRED EMBODIMENT

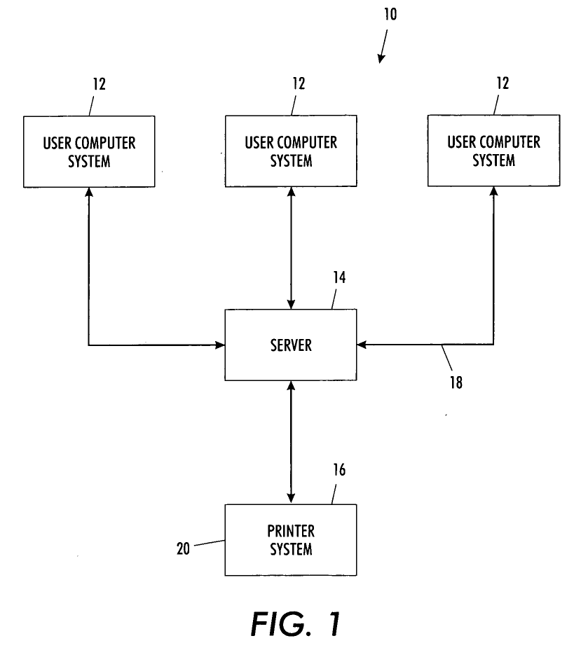

With reference to the drawings wherein like numerals represent like parts throughout the several figures, and more particularly to FIG. 1, there is shown a local area network 10 comprising multiple local user computer systems 12, a remote server 14 and a remote printer system 16. The user computer systems 12 are connected 18 to the server via the TCP/IP protocol.

Each user computer system 12 includes the standard components of a computer, a keyboard, a display and a mouse (none of which are shown). The user computer provides a secure printer process, or client, which is a software routine that can be initiated by a user when secure printing is required. An electronic printing system, such as one manufactured by Xerox Corporation, under the product name of “DocuTech.RTM.”, is capable of storing a job, in electronic form, for printing at a latertime. As indicated in U.S. Pat. No. 5,436,730 to Hube (Issued Jul. 25, 1995), the pertinent portions of which are incorporated herein by reference, such jobs may be stored in the main memory of the printer system controller 20.

In practice, the printer system controller 20 acts as a modified print spooler or print server process. The spooler or server is modified in the respect that it is arranged to recognize encrypted documents and, rather than printing them, holds or stores the encrypted documents until a print release command is entered by the user at the printer. As described above, it is not unusual for numerous secure print jobs to stay in the print queue for significant periods of time before a print release command is entered in this type of environment.

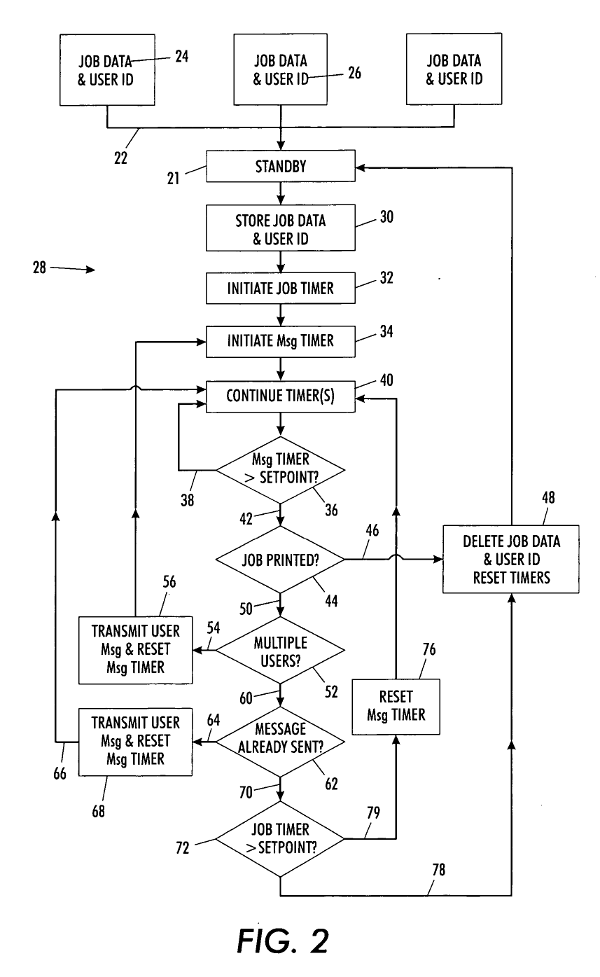

With reference to FIG. 2 the subject method for automatic secure print notification prevents users from simply forgetting that they have submitted a secure print job to the printer system 16. The secure print notification routine is in standby 21, waiting for secure print jobs from user computer systems 12 so long as the printer system 16 and server 14 are energized. When a user submits 22 a print job file 24 (or print job data) to the printer system 16, the user's computer system 12 also transmits user ID data 26. The user ID data 26 may include the user's email address for use by secure print notification routine 28 for transmitting messages to the user, as explained below. The user's email address may be also be used as an identifier for the user. Alternatively, the user ID data 26 may include a separate unique identifier for the user. If for some reason the user ID data is not automatically transmitted, the server 14 or the printer system 16 may query the user's computer system 12 for such ID data. Alternatively, the server 14 may simply identify the specific user computer system 12 that has provided the print job file 24 and associate user ID data 26 for the user computer system 12 with the print job file 24.

The printer system controller 20 then creates 30 a record in the secure print job database and stores the print job file 24 and associated user ID data 26 in the appropriate fields of the record. It should be appreciated that the record also includes fields for storing other information regarding the print job, as indicated in U.S. Pat. No. 5,436,730 to Hube. Amongst these additional fields is a field for storing the print status of the print job, that is whether or not the print job has actually been printed, and a field for storing the reminder status for the print job, as explained below.

The printer system controller 20 also initiates 32 a job timer and initiates 34 a message timer. The message timer and job timer are countdown devices. The message timer performs a function similar to a stop-watch, that starts when message timer is initiated 34. The job timer may also be a clock, if the print job is to be terminated if it has not been printed before a predetermined period of time has passed after the print job is submitted 22. Alternatively, the job timer may count the number of reminder messages that have been transmitted to the user, if the print job is to be terminated if it has not been printed before a predetermined number of reminder messages have been transmitted to the user.

Periodically, the printer system controller 20 queries 36 the message timer for each print job file 24 to determine whether the timer countdown has exceeded a preset timer interval. If the timer countdown is less than the time interval setpoint 38, the message timer continues 40 to countdown. If the timer countdown is greater than the time interval setpoint 42, the printer system controller then queries 44 the print job record to determine whether the print job has already been printed. A predetermined value is stored in the secure print notification routine 28 for the message timer setpoint. However, the message timer setpoint may be reset by system administrator. If the print job record indicates that the print job has been printed 46, the printer system controller deletes 48 the print job file 24 and user ID data 26 from the secure print notification routine 28 and returns to standby 21 for receipt of another secure print job.

If the printjob record indicates that the printjob has not been printed 50, the printer system controller 20 then determines 52 whether the print queue includes print jobs from more than one user. If all of the print jobs in the queue are from a single user 54, the printer system controller 20 transmits 56 a reminder message to the user, resets 58 the message timer, and restarts 34 the message timer. The message is a single reminder for all of the User's print jobs that are in the queue. The message may be in the form of an e-mail. The printer system controller 20 also annotates the print job record reminder status field to indicate that a reminder message has been transmitted to the user.

If the queue includes print jobs from more than one user 60, the printer system controller 20 then queries 62 print job database to determine whether a reminder has already been transmitted to the user. If the print job database reminder status field indicates that no reminder messages have been sent 64 to the user, the printer system controller 20 transmits 66 a reminder message to the user, resets 68 the message timer, continues 40 the job timer, and annotates the print job record reminder status field to indicate that a reminder message has been transmitted to the user. If the print job database reminder status field indicates that a reminder message has been sent 70 to the user, the printer system controller 20 queries 72 the job timer to determine whether the timer countdown has exceeded a preset timer interval. If the timer countdown is less than the time interval setpoint 74, the message timer is reset 76 and the message timer and the job timer continues 40 to countdown. A predetermined value is stored in the secure print notification routine for the job timer setpoint. However, job timer setpoint may be reset by system administrator. If the timer countdown is greater than the time interval setpoint 78, the printer system controller sends a message to the user that the print job has timed out and has been deleted from the queue, and then deletes 48 the print job file and user ID data from the secure print notification routine and returns to standby for receipt of another secure print job.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of managing secure print jobs in a distributed computer system including a remote printer system having a printer controller, the method comprising:
a user commanding a user computer system to submit a secure print job to be printed;
the user computer system transmitting the secure print job and user ID data associated with the user to the printer system through a network;
the printer system controller creating a record in a secure print job database and storing the print job file and user ID data in a print job field and an ID field of the record, respectively, the record also including a print status field that is annotated by the printer controller when the print job is printed; and
the printer controller periodically transmitting reminder messages to the user identified by the user ID data, the reminder messages informing the user that the secure print job is stored in a queue in the printer system and would be printed only on manual entry of an appropriate command at the printer system.

2. The method of claim 1 wherein after the printer system stores the print job file and user ID data, the printer controller:
initiates a message timer associated with the secure print job to countdown; and
periodically queries the message timer for each secure print job to determine whether the message timer countdown has exceeded a preset timer interval setpoint;
wherein if the message timer countdown is less than the time interval setpoint, the message timer continues to countdown, and if the message timer countdown is greater than the time interval setpoint, the printer controller transmits the reminder message to the user and resets the message timer to reinitiate countdown.

3. The method of claim 2 wherein after the printer system initiates the message timer, the printer controller:
initiates a job timer associated with the secure print job to countdown; and
periodically queries the job timer for each secure print job to determine whether the job timer countdown has exceeded a preset timer interval setpoint;
wherein if the job timer countdown is less than the time interval setpoint, the job timer continues to countdown, and if job the timer countdown is greater than the time interval setpoint, the printer controller deletes the print job file and user ID data and returns to standby for receipt of another secure print job.

4. The method of claim 3 wherein if job the timer countdown is greater than the time interval setpoint, the printer controller also transmits a message informing the user that the print job has been canceled.

5. The method of claim 2 wherein after the printer controller has determined that the timer countdown is greater than the time interval setpoint and before the printer controller transmits the reminder message to the user, the printer controller queries the print job record to determine whether the print status field has been annotated,
wherein if the print job record indicates that the print job has been printed, the printer controller deletes the print job file and user ID data and returns to standby for receipt of another secure print job;
wherein if the print job record indicates that the print job has not been printed, the printer controller transmits the reminder message to the user.

6. The method of claim 1 wherein periodically transmitting reminder messages comprises:
the printer controller initiating a message timer associated with the secure print job to countdown;
the printer controller initiating a job timer associated with the secure print job to countdown;
the printer controller querying the message timer for each secure print job to determine whether the message timer countdown has exceeded a preset timer interval setpoint; and
continuing the message timer countdown if the message timer countdown is less than the time interval setpoint.

7. The method of claim 6 wherein periodically transmitting reminder messages further comprises:
the printer controller querying the print job record to determine whether the print status field has been annotated if the message timer countdown is greater than the time interval setpoint; and
the printer controller deleting the print job file and user ID data and returning to standby for receipt of another secure print job if the print job record indicates that the print job has been printed.

8. The method of claim 7 wherein periodically transmitting reminder messages further comprises:
the printer controller determining whether the queue of print jobs includes print jobs from more than one user if the print job record indicates that the print job has not been printed; and
the printer controller transmitting a single reminder message to the user for all of the print jobs if all of the print jobs in the queue are from a single user.

9. The method of claim 8 wherein periodically transmitting reminder messages further comprises:
the printer controller querying the print job database to determine whether a reminder has already been transmitted to the user if the queue includes print jobs from more than one user;
the printer controller transmitting the reminder message to the user if no reminder messages have been sent to the user; and
the printer controller querying the job timer to determine whether the job timer countdown has exceeded a preset timer interval if a reminder message has already been sent to the user.

10. The method of claim 9 wherein periodically transmitting reminder messages further comprises:
resetting the message timer and continuing to countdown the job timer if the job timer countdown is less than the time interval setpoint; and
the printer controller sending a message to the user that the print job has timed out and has been deleted from the queue, deleting the print job file and user ID data and returning to standby for receipt of another secure print job if the job timer countdown is greater than the time interval setpoint.

11. A method of managing secure print jobs in a distributed computer system including a remote printer system having a printer controller, the method comprising:
a user commanding a user computer system to submit a secure print job to be printed;
the user computer system transmitting the secure print job and user ID data associated with the user to the printer system through a network;
the printer system controller creating a record in a secure print job database and storing the print job file and user ID data in a print job field and an ID field of the record, respectively;
the printer controller periodically transmitting reminder messages to the user identified by the user ID data, the reminder messages informing the user that the secure print job is stored in a queue in the printer system and would be printed only on manual entry of an appropriate command at the printer system; and
the printer controller deleting the print job file and user ID data if the print job is not printed within a predetermined period of time.

12. The method of claim 11 wherein before the reminder message is transmitted to the user, the printer controller:
queries the print job record to determine whether the print job has already been printed:
deletes the print job file and user ID data and returns to standby for receipt of another secure print job if the print job has been printed;
transmits the reminder message to the user if the print job has not been printed.

13. The method of claim 11 wherein before the reminder message is transmitted to the user, the printer controller:
determines whether the user has more than one print job in the queue of print jobs; and
transmits a single reminder message to the user for all of the print jobs in the queue of print jobs associated with the user.

14. The method of claim 11 wherein before the reminder message is transmitted to the user, the printer controller:
determines whether the queue of print jobs includes print jobs from more than one user;
queries the print job database to determine whether a reminder has already been transmitted to the user if the queue includes print jobs from more than one user;
transmits the reminder message to the user if no reminder messages have been sent to the user.

15. A distributed computer system comprising:
a network;
at least one local user computer system that submits a secure print job and user ID data associated with a user to the network; and
a remote printer system including
a memory that stores the secure print job and user ID data received from the network, and
a printer controller that periodically transmits reminder messages to the user identified by the user ID data, the reminder messages informing the user that the secure print job is stored in a queue in the printer system and would be printed only on manual entry of an appropriate command at the printer system.

16. The distributed computer system of claim 15 wherein the printer controller initiates a job timer associated with the secure print job to countdown and deletes the print job file and user ID data from the memory if the job timer countdown has exceeded a preset timer interval setpoint.

17. The distributed computer system of claim 16 wherein if job the timer countdown is greater than the time interval setpoint, the printer controller also transmits a message to the at least one user computer system that the print job has been canceled.

18. The distributed computer system of claim 15 wherein the printer controller determines whether the queue of print jobs includes print jobs from more than one user and transmits a single reminder message for all of the print jobs if all of the print jobs in the queue are from a single user.
